(19) United States
(12) Patent Application Publication
(10) Pub. No.: US 2010/0070981 A1
(43) Pub. Date: Mar. 18, 2010

(54) System and Method for Performing Complex Event Processing

(75) Inventors: Ethan Hadar, Nesher (IL); Jeffrey A. Vaught, Batavia, OH (US); Avigdor Gal, Haifa (IL)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/553,416

(22) Filed: Sep. 3, 2009

Related U.S. Application Data
(60) Provisional application No. 61/097,439, filed on Sep. 16, 2008.

(51) Int. Cl. G06F 9/54

(52) U.S. Cl. 719/318

(57) ABSTRACT

A method for performing complex event processing includes receiving events from at least one entity at a grid of complex event processing (CEP) units, each of the CEP units comprising a modular architecture for receiving events from event suppliers, recursively processing events, and transmitting events to event consumers. The method further includes generating event inferences based on the plurality of events by one or more CEP units of the grid of CEP units.

### RELATED APPLICATIONS

This application claims the benefit under 35 U.S.C. § 119(e) of the priority of U.S. Provisional Application No. 61/097,439 filed Sep. 16, 2008, entitled “System and Method for Performing Complex Event Processing.”

### TECHNICAL FIELD

The present disclosure relates generally to event processing, and more particularly to a system and method for performing complex event processing.

### BACKGROUND

Systems exist that identify and respond to events. These systems are also referred to as active systems. An event may include any mechanism for delivering data. For example, an event may include a notification from a database. An event may be generated by several sources. For example, an event may be generated by some mechanism external to the active system. As another example, an event and its related data may be inferred by the active system. Active systems may identify relevant events and patterns by analyzing multiple events. However, existing systems used for performing this analysis are sometimes inefficient and unreliable.

### SUMMARY

According to the present invention, disadvantages and problems associated with previous techniques for performing complex event processing may be reduced or eliminated.

In certain embodiments, a method for performing complex event processing includes receiving events from at least one entity at a grid of complex event processing (CEP) units, each of the CEP units comprising a modular architecture for receiving events from event suppliers, recursively processing events, and transmitting events to event consumers. The method further includes generating event inferences based on the plurality of events by one or more CEP units of the grid of CEP units.

Technical advantages of particular embodiments of the present disclosure may include the following compliance and governance benefits: a separation of concerns between different CEP units that can interact in a form of a grid of CEP units; a simple and dynamic way to integrate CEP instances; a technique to reduce computation efforts within each of the CEP units; a centralized governance and compliance supportive arena, enabling CEP service virtualization capabilities; and a scalable and highly available solution.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram illustrating a system for performing complex event processing, according to the teachings of the present disclosure;

FIG. 2 is a diagram illustrating one embodiment of a distributed grid of complex event processing, according to the teachings of the present disclosure;

FIG. 3 is a diagram illustrating one embodiment of a modular architecture of a single CEP unit for performing complex event processing, according to the teachings of the present disclosure;

FIG. 4 is a diagram illustrating details of the modular architecture of FIG. 3, according to the teachings of the present disclosure;

FIG. 5 is a diagram illustrating details of the event situation management service of FIG. 4, according to the teachings of the present disclosure; and

FIG. 6 is a flow diagram illustrating a method for performing complex event processing, according to the teachings of the present disclosure.

### DESCRIPTION OF EXAMPLE EMBODIMENTS

In recent years, there has been a growing need for the use of active systems. For example, active systems may perform automatic actions that may be reactive, such as responding to provided stimuli. As another example, active systems may perform automatic actions that may be proactive, such as predicting possible phenomena. While earliest active systems were directed to databases, a current major need for such active functionality covers other areas such as Business Activity Monitoring (BAM) and Business Process Management (BPM). Concurrent with the proliferation of such applications, the events to which active systems respond have expanded from Information Technology (IT) systems and application-level events to business-level events. Active systems may encompass many levels of IT, from IT infrastructure events to business level objectives, and are used in a wide spectrum of sectors including financial and e-Trading, business process management, system management, client relationship management (CRM), workflow management, and military applications.

The main primitive in many active systems is an event. An event refers to any mechanism for delivering data. For example, an event may be an actual occurrence or happening that is significant (falls within a domain of interest to the system). An event may be instantaneous (takes place at a specific point in time) and atomic (it either occurs or not). Examples of events may include a database notification, a termination of workflow activity, a report on daily sales, a person entering or leaving a certain geographical area, a server joining the network, and a CPU reaching a certain utilization threshold.

An event may be generated by several sources. For example, an event may be generated by some mechanism external to the active system, also referred to as explicit events. As another example, an event and its related data may be inferred by the active system, also referred to as materialized events.

A complex event refers to any inference that may be drawn from the events. For example, a complex event may be the simple aggregated sum of the individual metrics accumulated from separate, service related, servers. Complex event processing (CEP) supports the inference of events based on event notification history and the data delivered by events. From an industrial point of view, CEP may be performed by distributed, asynchronous, message-based systems, such as enterprise applications that can immediately act upon business critical events.

Each complex event may depend on underlying primitive events and/or previously calculated complex events. In addition, each of these complex events may be generated by domain-specific business rules and languages, as described below.

A rule refers to any set of conditions for the generation of events. For example, a rule may define the number of new events to materialize and may assist in calculating their attributes and probabilities. A rule may contain a selection function that filters events relevant to the rule. Such a selection function may receive an event history as input, and return a filtered subset of the history with selectable events. The selection expression may filter out events that are not relevant for generating an event inference according to the rule.

A rule may include a predicate, defined over a filtered event history that determines when events become candidates for the rule. While the selection function may eliminate events that are, by themselves, irrelevant, the predicate may determine the relevance of sets of events.

A rule may include an association function. An association function may define how many complex events to generate, as well as which subsets of selectable events are associated with each new event. A mapping function may determine the attribute values of new events.

For example, a rule may detect a flu outbreak whenever there is an increase in over-the-counter cough medication sales for four sequential days with a total increase of 350 units. In the example, both the selection operator and the predicate may identify over-the-counter cough medication sales as the relevant events. The association function identifies consecutive sales with an increase of 350 units. The mapping function may generate a new event, determining a flu outbreak.

As the above example illustrates, CEP may involve intense computation efforts. Thus, scalability, flexibility, and manageability are import aspects for any CEP solution.

In accordance with the teachings of the present disclosure, CEP is performed by a modular architecture. In particular embodiments, the modular architecture may include: 1) a separation of concerns between different CEP instances that can interact in a form of a grid of CEP instances; 2) a simple and dynamic way to integrate CEP instances; 3) a technique to reduce computation efforts within each of the CEP instances; 4) a centralized governance and compliance supportive arena, enabling CEP service virtualization capabilities; and 5) a scalable and highly available solution.

According to certain embodiments of the present disclosure, the modular architecture may provide CEP service virtualization, compliance and governance of complex events policies, purified events storage, reduced calculation efforts, dynamic grid binding, and deployment of alternatives according to complexity and scalability. For example, the modular architecture may provide CEP service virtualization by providing enterprise-level managed-CEP policies that enable high availability and control mechanisms such as service level agreements (SLAs). As another example, the modular architecture may provide compliance and governance of complex events policies by enabling a single point of view using dashboards, reports, and a life cycle of monitored events. As another example, the modular architecture may provide purified events storage by enabling analytics and trends analysis for providing proactive problem prevention. As another example, the modular architecture may provide reduced calculation efforts by recursively feeding complex events that prevents cyclic dependency and enables reuse of event detection and calculation efforts. As another example, the modular architecture may provide dynamic grid binding by weaving CEP units into a mesh of events management and thereby support scalability and high availability of the CEP system. As another example, the modular architecture may provide deployment of alternatives according to complexity and scalability by deploying a CEP unit separately from the system, which enables a grid structure. The CEP unit may be deployed according to certain levels of complexity, which enables flexibility in providing certain levels of solutions according to customer demands. Additional details of example embodiments of the present disclosure are described in detail below.

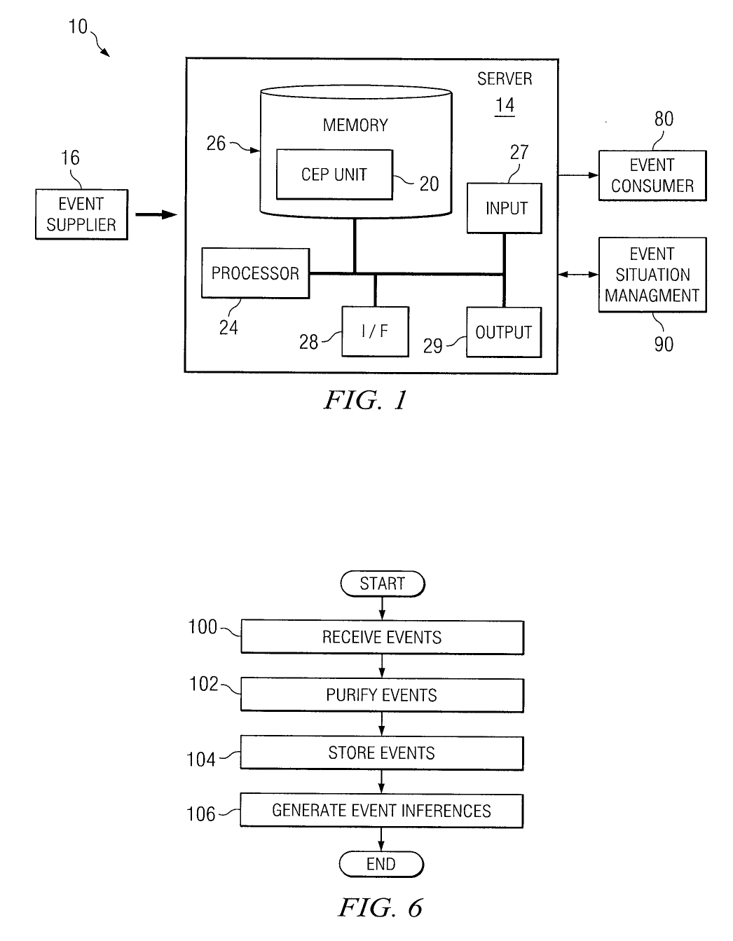

FIG. 1 is a block diagram illustrating a system for performing complex event processing, according to the teachings of the present disclosure. System 10 generally includes a server 14, one or more event suppliers 16, one or more CEP units 20, one or more event consumers 80, and one or more event situation management services 90. In particular embodiments, CEP units 20 receive and/or retrieve events from event suppliers 16. CEP units 20 transmit complex events to event consumers 80. In particular embodiments, CEP units 20 may be managed by event situation management service 90.

Server 14 may refer to any suitable device operable to perform CEP. Examples of server 14 may include a host computer, database server, workstation, web server, file server, a personal computer such as a laptop, or any other suitable device. Server 14 may include any operating system such as MS-DOS, XP, Linux, Sun, PC-DOS, MAC-OS, WINDOWS, UNIX, or other appropriate operating systems, including future operating systems.

Event supplier 16 may refer to any suitable logic and/or hardware that supplies events to CEP unit 20. Although illustrated as a single event supplier 16, particular embodiments of the present disclosure may include a distributed grid network of event suppliers 16. For example, event supplier 16 may refer to a database that supplies a database notification to CEP unit 20. As another example, event supplier 16 may refer to a location device that supplies a notification of a person entering a certain geographical area to CEP unit 20.

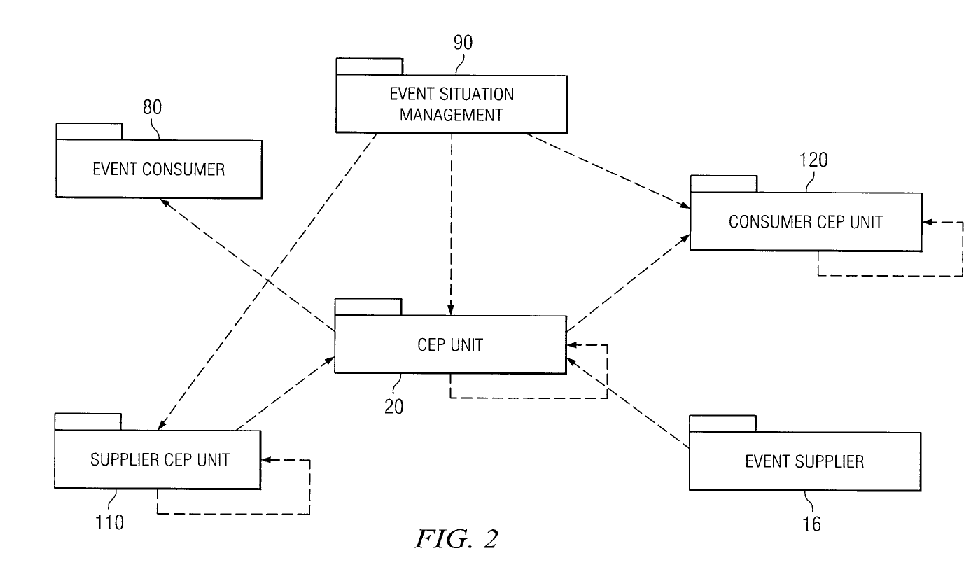

CEP unit 20 may include any suitable logic and/or hardware that receives events and transmits events and/or complex events to event consumers 80. Although illustrated as a single CEP unit 20, particular embodiments of the present disclosure may include a distributed grid network of CEP units 20. As described in more detail below, CEP 20 may interact with itself by recursively processing events. Additional details of example embodiments of CEP unit 20 are described in detail below with reference to FIGS. 2-4.

Event consumer 80 may refer to any suitable logic and/or hardware that receives and/or retrieves events from CEP unit 20. Although illustrated as a single event consumer 80, particular embodiments of the present disclosure may include a distributed grid network of event consumer 80. For example, event consumer 80 may include a disaster management system. In the example, CEP unit 20 may identify a complex event that includes a particular hazard event based on available data sources such as over-the-counter and pharmacy medication sales, calls to nurse hotlines, school absence records, web page hits of medical Web sites, and complaints of individuals entering hospital emergency departments. CEP unit 20 may supply the identified complex event to the disaster management system.

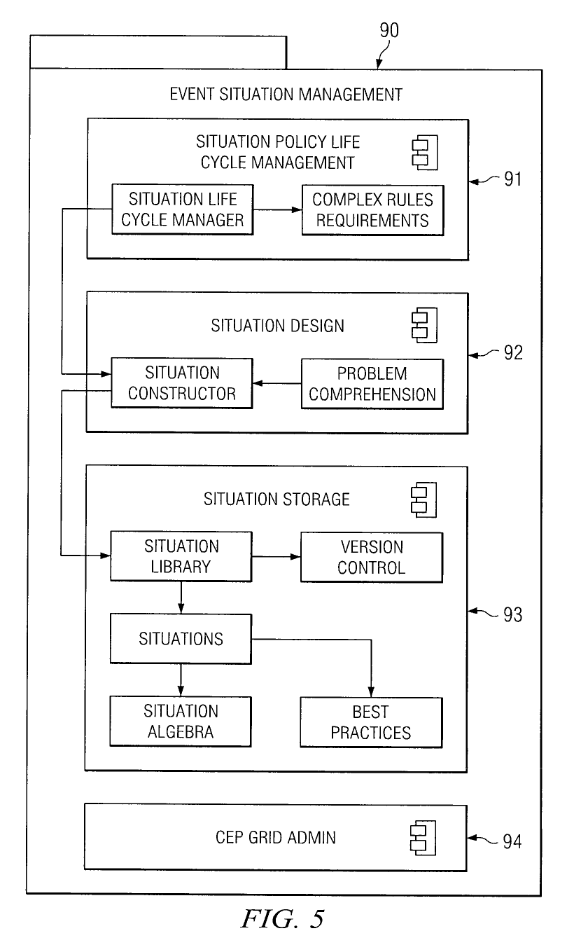

Event situation management service 90 may refer to any suitable logic and/or hardware that manages CEP units 20. For example, event situation management service 90 may manage the rules for CEP units 20. As another example, event situation management service 90 may manage a grid structure and performance optimization for CEP units 20. As yet another example, event situation management service 90 may support compliance regulations of events and generate a single dashboard and reporting mechanism for CEP units 20. Additional details of example embodiments of event situation management service 90 are described in detail below with reference to FIG. 5. Additional details of the other components of server 14 are described below.

Processor 24 may refer to any suitable device operable to execute instructions and manipulate data to perform operations for server 14. Processor 24 may include, for example, any type of central processing unit (CPU).

Memory device 26 may refer to any suitable device operable to store and facilitate retrieval of data, and may comprise Random Access Memory (RAM), Read Only Memory (ROM), a magnetic drive, a disk drive, a Compact Disk (CD) drive, a Digital Video Disk (DVD) drive, removable media storage, virtual network storage device, or any other suitable data storage medium, or a combination of any of the preceding. Although CEP unit 20 is illustrated as stored in memory device 26, in particular embodiments, some, all, or none of the components illustrated in FIG. 1 including event supplier 16, CEP unit 20, event consumer 80, and event situation management service 90 may be stored in memory device 26 and executed on server 14.

Communication interface (I/F) 28 may refer to any suitable device operable to receive input, send output, perform suitable processing of the input or output or both, communicate to other devices, or any combination of the preceding. Communication interface 28 may include appropriate hardware (e.g. modem, network interface card, etc.) and software, including protocol conversion and data processing capabilities, to communicate through a LAN, WAN, web service, or other communication system that allows server 14 to communicate to other devices. Communication interface 28 may include one or more ports, conversion software, or both.

Input device 27 may refer to any suitable device operable to input, select, and/or manipulate various data and information. Input device 27 may include, for example, a keyboard, mouse, graphics tablet, digital sensor, joystick, light pen, microphone, scanner, or other suitable input device.

Output device 29 may refer to any suitable device operable for displaying information to a user. Output device 29 may include, for example, a video display, a printer, portlet, a plotter, or other suitable output device. Additional details of example embodiments of the disclosure are described in greater detail below in conjunction with portions of FIGS. 2-6.

FIG. 2 is a diagram illustrating one embodiment of a distributed grid of complex event processing, according to the teachings of the present disclosure. The illustrated embodiment includes a general architecture of CEP as a grid of suppliers and consumers of events. For example, CEP unit 20 may receive events from a supplier CEP unit 110 as well as from a regular event supplier 16 (any event source). CEP unit 20 may provide complex events to event consumers 80 and a consumer CEP unit 120 (serving as a supplier CEP unit to that consumer). CEP unit 20 may be managed by event situation management service 90.

The grid CEP network illustrated in FIG. 2 provides a modular representation of the interaction between CEP systems, where each CEP unit 20 may generate or consume events and be managed and configured by event situation management service 90. This approach enables service transparency in which the exact implementation instance of the CEP unit 20 is hidden from the consumer of events, as well as overall grid performance characteristics can be optimized globally amongst CEP units 20. In particular embodiments, the events may be transmitted from one unit to another based on the dynamic configuration and weaving of CEP units 20 as defined by event situation management service 90.

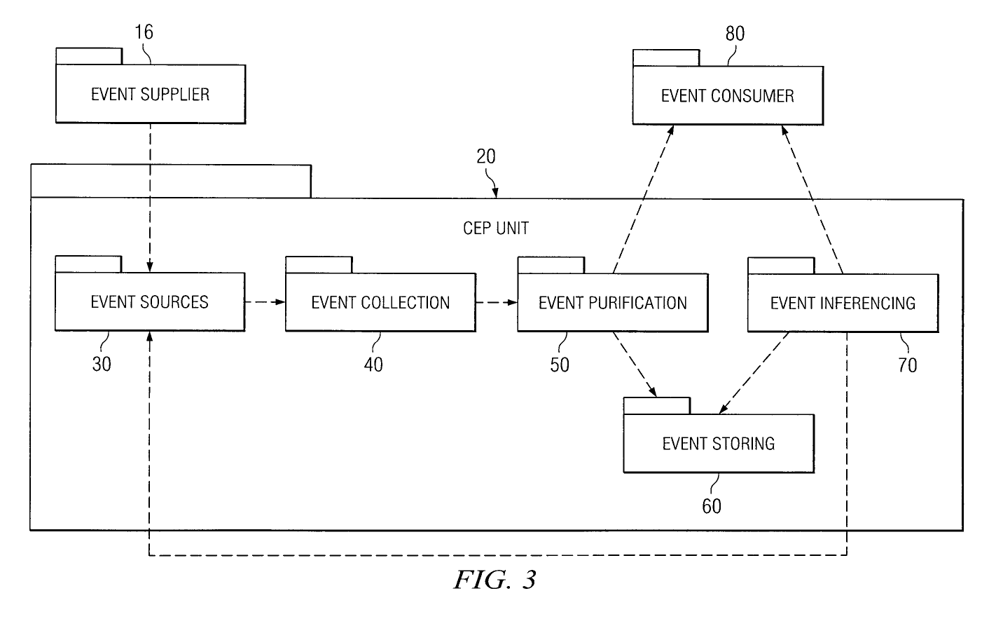

FIG. 3 is a diagram illustrating one embodiment of a modular architecture of a single CEP unit 20 for performing complex event processing, according to the teachings of the present disclosure. In the illustrated embodiment, CEP unit 20 includes an event sources component 30, an event collection component 40, an event purification component 50, an event storing component 60, and an event inferencing component 70.

In particular embodiments, CEP unit 20 may include an event sources component 30 for each event source monitoring incoming events. Event collection component 40 captures events and filters redundant events. Event purification component 50 adds information to the events and adapts their structure and format. Event storing component 60 supports persistency as well as analytics of events. Event inferencing component 70 provides the actual engine to calculate a situation if detected and dispatches the inferred events. Thus, this flow illustrates the main steps in CEP as supported by the modular grid architecture for CEP. From sampling of events through collection, purifications, storing, inferencing, design and management, this model supports modular combinations of deployment and solutions.

As described below, the internal recursive mechanism of CEP unit 20 enables the weaving of a grid network of CEP units 20, as well as minimizes the computation efforts in detecting situations. Therefore, events may be proactively triggered and sampled based on needs, thus improving root-cause capabilities in an ad-hoc manner without overusing system resources.

In particular embodiments, centralized control by event situation management service 90 enables remote configuration of local CEP unit 20 behavior in terms of shedding of information according to a global grid need. For example, one can stop sampling a primitive event at the entry to the grid, in order to prevent its consumption several CEP units ahead, thus eliminating the processing of that event. Overall sampling frequency of events may be balanced accordingly. The remote administrator may enable the replacement of rules between CEP units 20, event sources links, as well as overall system load balancing and redundancy tuning.

In particular embodiments, remote centralized management provides CEP service virtualization seamlessly to users. It facilitates compliance with regulations in defining rules for situation detections, thus enabling the monitoring of business process and underlying activities in the operation domain, as well as detecting system behavior.

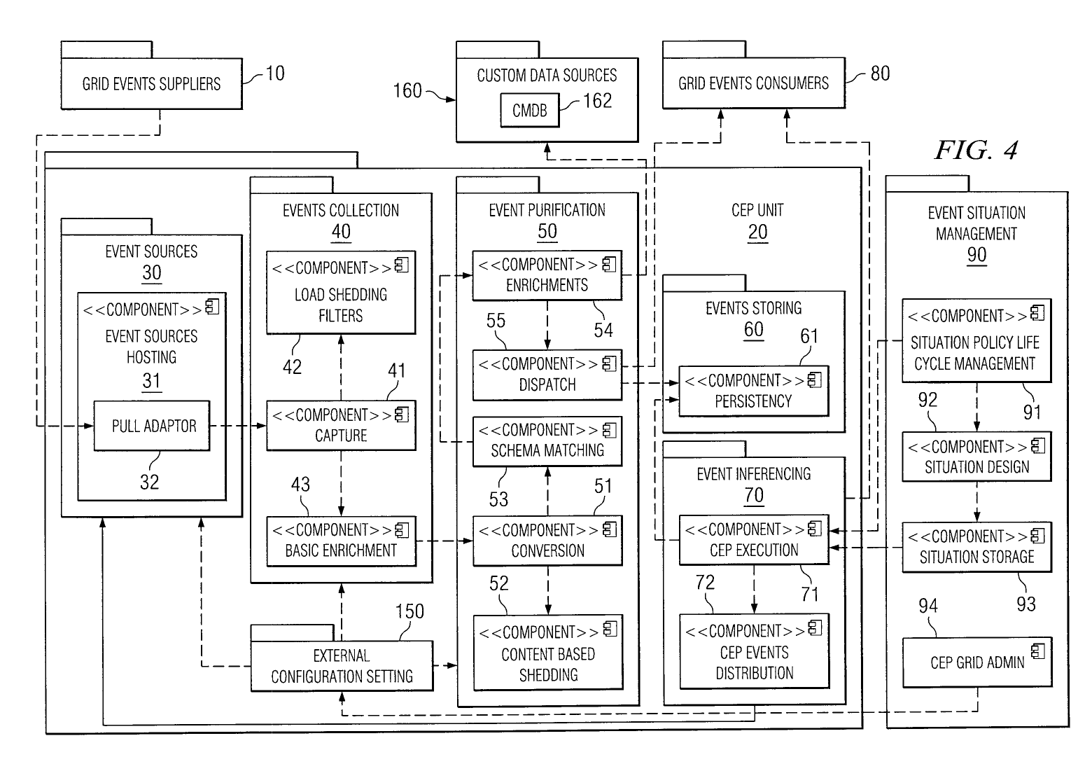

In particular embodiments, centralized storage, integrated as federated distributed storage, enables analysis and trends detections, thus serves as a fundamental block in automatic discovery of business process, based on analyzing the measured qualitative events. It may enable problem detection and awareness based on previous patterns, thus supporting problem prevention capabilities in IT systems. Additional details of the modular architecture of FIG. 3 are described below with reference to FIG. 4.

FIG. 4 is a diagram illustrating details of the modular architecture of FIG. 3, according to the teachings of the present disclosure. In the illustrated embodiment, event sources component 30, event collection component 40, event purification component 50, event storing component 60, and event inferencing component 70 each include several sub-components. Details of particular embodiments of each of these components and sub-components are described below.

In particular embodiments, event sources component 30 and its hosting capabilities extract real world events from external sources. For example, events may be pushed from an external source and put in a queue of incoming events. However, not all events may be delivered all the time. Some events may be received over dedicated channels listening to event sources. In particular embodiments, some events may be retrieved periodically to avoid the abuse of the network. For example, technologies such as Really Simple Syndication (RSS) feeds monitor retrieve-based streams.

In particular embodiments, a pull adaptor component 32 in event sources component 30 may sample events and monitor external queues for pushed events. Pull adaptor component 32 may serve as a boundary system and transform technological difficulties between the sampled information and the system technology. As an example, if the event information is organized as a string formed message, in order to recognize the information, a specific adapter may read the information, detect its content, and parse it into a structured format that later on can be machine readable as any other information. These specialized adapters may wrap one technology and transform it to another. Particular embodiments of the present disclosure may use any existing, well-known protocols such as Simple Object Access Protocol (SOAP) messages, Transmission Control Protocol (TCP) query, and Simple Network Management Protocol (SNMP) in order to investigate and query a device, such as a server.

In particular embodiments, event sources component 30 passes monitored events to event collection component 40. Event collection component 40 may capture the events by triggering and scheduling of an adaptor in the event sources hosting 31 to run. A load shedding filters component 42 may reduce the number of propagated events into the system based on the system internal logic. For example, if an external event source is known to undergo maintenance, then events from this source may be discarded. The shedding policy may be configured for a specific CEP unit 20 locally, as well as remotely adjusted by event situation management service 90. A basic enrichment component 43 decorates the sample events with basic information such as a time stamp, event type and event source, and forwards the events to event purification component 50.

In particular embodiments, event purification component 50 enriches the event with semantic information, as opposed to the minimal, mainly syntactical enrichment performed by event collection component 40. A conversion component 51 may retrieve the filtered events from event collection component 40, and classify them for improved performance. For example, the events may have originated from a specific resource such as a database server. Other classifications may include the events that originated from a region of IP addresses, and another might be classified on the type of events in order to improve the processing batch capabilities. A content based shedding component 52 may perform another level of shedding to improve efficiency. For example, one difference between the content based shedding component and the regular load shedding filters component in event collection component 40, is that load shedding filters component 42 may not sample events entirely, eliminating any entry of events to the system by stopping a port from listening to events, and/or by not running a certain adaptor. The example may include a situation where a server might be restarting periodically due to an upgrade activity. During this time, the server is not in production mode, and thus does not participate in the overall IT system. However, if not removed by this external shedding, it may insert redundant events into the system. In the case of content based shedding component 52, a synchronic communication protocol may be implemented, in which the system receives an event “once and only once,” similar to a digital flip-flop gate, protecting the system from reacting to a recurring event, and acting upon it within a reasonable time. Therefore, the system may receive an event, recognize it as being already processed, and thus, prohibit its propagation.

In particular embodiments, incoming events may be normalized, formatted and validated in terms of content and may be transformed into a new schema by schema matching component 53. If content based shedding is not frequently used, its activation may not be in a sequential manner but rather triggered and activated upon the conversion mechanism transient detection.

In particular embodiments, the system may add missing information using an enrichments component 54. For example, information may be received from external information sources, such as from a configuration management database (CMDB) 162 component from a custom data source 160 and/or based on pre-defined structured algorithm, configured from a remote administrator.

In particular embodiments, the basic purified events may be sent to event storing component 60 and/or event consumer 80 that receive those purified events according to the dynamically configured dispatching information, stored at the dispatch component. The event storing component 60 enables the warehousing of the received events that will be processed later by event inferencing component 70. Event storing component 60 stores the qualitative events, based on transient needs, and facilitates archiving and purging of old data, as well as analytical processing of futuristic trends and statistics. The notion of purified storage may be of importance for most of the analytical engines, since in order to correlate events, or harvest logs, one may have a unified, semantically understood, single format of data. Otherwise, the system may apply intense calculations efforts for transient translations and may repeat the calculations periodically.

In particular embodiments, event inferencing component 70 generates new events given an existing event history. A CEP execution engine component 71 may use purified events, the output of a persistency storage component 61, and executes active situations policies defined by event situation management service 90. Based on the outcomes of the rules, three major actions may be derived as described below.

First, a need for additional probing may be derived, either direct or deferred, by triggering the same pull adaptor component 32 to retrieve more events and more information. This mechanism of recursive probing may reduce the calculation efforts in the system. For example, degradation may be detected in a transaction's overall performance from the time a user submits a query until a response is generated. The root-cause for this degradation may be caused by a load on system resources the database server, or load on the network hub, or memory leakage on the web server. Instead of constantly measuring these three attributes, a rule is defined that activates a need to measure CPU, or memory utilization, in the case that the overall transaction's performance is less than 3 seconds. Thus, an additional probe conditional to a threshold is actuated and defined by a situation.

Second, a need to send detected complex events to any regular CEP clients using a CEP events distribution component 72 may be derived. For example, a load balancer farm that instantiates a new server and adds it to the computer farm may be adding or removing servers according to several conditions. These conditions may include the number of running transactions that are more than 100 AND the accumulated free memory that is less than 30% AND the overall average CPU time within the last 1 hour that is more than 70%. The load balancer may constantly monitor these aggregated conditions and act upon the changes in the statuses.

Third, a need to store the detected complex events may be derived. This is done, in one embodiment, by the CEP events distribution component 72, and sent to event sources component 30 and the pull adaptor component 32 to re-enter the system. Reduced calculation effort may be achieved here through the use of recursive storage. Observing the previous example, the first two conditions may be defined (transactions and free memory) as an internal rule called “Transaction and Free Memory (TAM).” Consequently, the rule may be transformed into TAM AND Average CPU. Moreover, the database server itself may be interested in the TAM rule for self-adaptation needs, in which it will add storage on demand to the same server by using remote a Internet Small Computer System Interface (iSCSI) storage memory, which enables the utilization of storage over internet network. In such a case, computing the TAM rule for both complex rules again may be redundant. The system may detect this similarity of the rules, thus define a common granular TAM rule that may be used by CEP rule consumers, a load balancer, as well as a database storage self-adaptation service.

In particular embodiments, event inferencing component 70 operates on the active CEP rules. For example, event inferencing component 70 may operate on those rules to which consumers are registered. This property may increase performance and reduces computation efforts of the system. As described, in more detail below, a CEP grid administration component 94 may remotely configure each CEP instance by way of an external configuration setting component 150 that may submit regular load shedding rules and content based shedding ones. Details of event situation management service are described below with reference to FIG. 5.

FIG. 5 is a diagram illustrating details of event situation management service 90 of FIG. 4, according to the teachings of the present disclosure. Event situation management service 90 provides CEP service virtualization capabilities, by managing the CEP rules and the CEP grid structure as well as its performance optimization. This capability of centralized design and life cycle management supports compliance regulations of events and a single dashboard and reporting mechanism to the CEP service.

The situation policy rules construction, design and execution may be managed by a situation policy life cycle management component 91 that gathers compliance or any other requirements for CEP rules. It may use a situation design component 92 to construct a new situation based on the problem comprehension. By using the stored situations in the situation storage component, it can either reuse situations as defined by the best practices and/or construct new ones by using situation algebra. The designer component optimizes the collective rules into aggregated policies and detects the complex rules to be stored within the system itself to reduce calculations and those that may not be stored.

In particular embodiments, after defining a new situation, and detecting the need to deploy it, the situation policy life cycle management component 91 deploys the situation in any of the managed CEP units 20 that are available on the grid. A CEP grid administration component 94 may remotely configure each CEP instance in terms of submitting regular load shedding rules and content based shedding ones. In particular embodiments, it can instruct the CEP unit to which adaptor to connect and run. In particular embodiments, it can define the connectivity of the instance in terms of what to sample in the case of pull adaptor components and where to dispatch the events centrally. Centrally configuring the providers of the grid and the consumers of the CEP and process events does not contradict the ability to configure this locally on a single instance. The discrepancy between the locally configured options, and the centrally defined options are aggregated and reported back to event situation management service 90 in order to analyze the reason and adjust the overall gird performance, as well as adhere to the compliance and governance needs. Thus, event situation management service 90 supports the CEP service virtualization, dynamic binding of grid, and the compliance and governance benefits.

FIG. 6 is a flow diagram illustrating a method for performing complex event processing, according to the teachings of the present disclosure. In particular embodiments, the method may be performed by CEP Unit 20 as described above with reference to FIG. 1. The method begins at step 100 where events are received from at least one entity. For example, a CEP unit may include an event sources component for each event source monitoring incoming events. An event collection component captures events and filters redundant events. In particular embodiments, the CEP unit may retrieve events from the entity. At step 102, the events are purified. For example, an event purification component adds information to the events and adapts their structure and format. At step 104, the purified events are stored. For example, an event storing component supports persistency as well as analytics of events. At step 106, event inferences are generated. For example, an event inferencing component provides the actual engine to calculate a situation if detected and dispatches the events.

Thus, the present disclosure illustrates the main steps in CEP as supported by the modular grid architecture for CEP. From sampling of events through collection, purification, storing, inferencing, design and management, this model supports modular combinations of deployment and solutions.

For example, network and systems managers may utilize the modular architecture described above in order to provide safeguards for critical business processes. In the domain of Enterprise IT Management (EITM), the IT managers and their Chief Information Officer (CIO) may maintain qualitative operation levels of the managed IT resources. They may do so while aligning the production IT infrastructure to business needs of the organization, and measure its service quality levels in several terms, known as Key Performance Indicators (KPI). The managed resources, known as Configuration Items (CI), may be configured to change their behavior and/or be subjected to architectural changes that may include a different action. In particular embodiments, this may take place manually. In other embodiments, this may take place automatically. Moreover, there may be a dependency structure between the CIs that can affect the need for an action and/or compose an aggregated KPI.

As an example, the CI may be a logical IT service, such as a credit card validation, comprised of a business process that uses mail servers, web server and database servers for fulfilling the process. The overall performance metric of the credit card IT service is the accumulative sum of the separate transactions on each server. The overall malfunctions metric, is the number of reported requests for repair (service request). It is aggregated as well and defines the IT credit card Service quality metric.

An IT managers' operational needs may include reducing the number of malfunctions, or increase the performance of the IT service, according to a preset threshold, thus constructing the KPI. Upon relative distance to the KPI, or upon passing that indicator, an event is generated and sent to the IT manager.

In the example, there may be other complex rules such as financial implications of downtime, in which the threshold may be defined in currency measurements, and may be translated to the financial value of a server, as well as the potential lost of transactions. Thus, a complex event may detect a downtime server event, correlate it to the transactional business service it supports, aggregate the overall value, and compare it to the set financial threshold.

As another example, disaster managers may utilize the modular architecture described above in order to deal with and avoid risks. Disaster management involves preparing for disaster before it happens, disaster response, and rebuilding society after natural or human-made disasters have occurred.

An example of disaster management exists in health-related surveillance systems, which are designed to detect outbreaks including epidemics and bio-terrorist attacks. Such systems use data from external data sources (e.g., transactional databases) and expert knowledge to identify outbreaks and to quantify the outbreak attributes, such as the severity of an attack. Responding quickly to such attacks includes recognizing that an attack has occurred. Therefore, hazard events may be identified based on available data sources such as over-the-counter and pharmacy medication sales, calls to nurse hotlines, school absence records, web page hits of medical Web sites, and complaints of individuals entering hospital emergency departments.

Numerous other changes, substitutions, variations, alterations and modifications may be ascertained by those skilled in the art and it is intended that the present disclosure encompass all such changes, substitutions, variations, alterations and modifications as falling within the spirit and scope of the appended claims. Moreover, the present disclosure is not intended to be limited in any way by any statement in the specification that is not otherwise reflected in the claims.

What is claimed is:

1. A method for performing complex event processing, comprising:
receiving a plurality of events from at least one entity at a grid of complex event processing (CEP) units, each of the CEP units comprising a modular architecture for receiving events from event suppliers, recursively processing events, and transmitting events to event consumers; and
generating a plurality of event inferences based on the plurality of events by one or more CEP units of the grid of CEP units.

2. The method of claim 1, further comprising filtering the plurality of events by one or more CEP units of the grid of CEP units according to one or more criteria.

3. The method of claim 1, further comprising classifying the plurality of events by one or more CEP units of the grid of CEP units according to one or more criteria.

4. The method of claim 1, further comprising purifying the plurality of events by one or more CEP units of the grid of CEP units by enriching the plurality of events with semantic information.

5. The method of claim 1, further comprising storing the plurality of events by one or more CEP units of the grid of CEP units.

6. The method of claim 1, further comprising identifying one or more situations based on the plurality of events by one or more CEP units of the grid of CEP units.

7. The method of claim 1, further comprising transmitting the plurality of event inferences by one or more CEP units of the grid of CEP units to one or more event consumers.

8. A system for integrating cloud computing systems, comprising:
one or more processing units operable to:
receive a plurality of events from at least one entity at a grid of complex event processing (CEP) units, each of the CEP units comprising a modular architecture for receiving events from event suppliers, recursively processing events, and transmitting events to event consumers; and
generate a plurality of event inferences based on the plurality of events by one or more CEP units of the grid of CEP units.

9. The system of claim 8, wherein the one or more processing units are operable to filter the plurality of events by one or more CEP units of the grid of CEP units according to one or more criteria.

10. The system of claim 8, wherein the one or more processing units are operable to classify the plurality of events by one or more CEP units of the grid of CEP units according to one or more criteria.

11. The system of claim 8, wherein the one or more processing units are operable to purify the plurality of events by one or more CEP units of the grid of CEP units by enriching the plurality of events with semantic information.

12. The system of claim 8, wherein the one or more processing units are operable to store the plurality of events by one or more CEP units of the grid of CEP units.

13. The system of claim 8, wherein the one or more processing units are operable to identify one or more situations based on the plurality of events by one or more CEP units of the grid of CEP units.

14. The system of claim 8, wherein the one or more processing units are operable to transmit the plurality of event inferences by one or more CEP units of the grid of CEP units to one or more event consumers.

15. Software for integrating cloud computing systems, the software embodied in a computer-readable medium and when executed operable to:
receive a plurality of events from at least one entity at a modular architecture, the modular architecture comprising at least a first complex event processing (CEP) unit that recursively processes events, at least a second CEP unit that receives events from event suppliers, and at least a third CEP unit that transmits events to event consumers; and
generate a plurality of event inferences based on the plurality of events by at least one of the first CEP unit, the second CEP unit, and the third CEP unit.

16. The software of claim 15, further operable to filter the plurality of events by one or more CEP units of the grid of CEP units according to one or more criteria.

17. The software of claim 15, further operable to classify the plurality of events by one or more CEP units of the grid of CEP units according to one or more criteria.

18. The software of claim 15, further operable to purify the plurality of events by one or more CEP units of the grid of CEP units by enriching the plurality of events with semantic information.

19. The software of claim 15, further operable to store the plurality of events by one or more CEP units of the grid of CEP units.

20. The software of claim 15, further operable to identify one or more situations based on the plurality of events by one or more CEP units of the grid of CEP units.
